(19) United States
(12) Patent Application Publication
(10) Pub. No.: US 2017/0301531 A1
(43) Pub. Date: Oct. 19, 2017

(54) ION MOBILITY SPECTROMETER

(71) Applicant: SHIMADZU CORPORATION, Kyoto-shi (JP)

(72) Inventor: Yusuke TATEISHI, Kyoto-shi (JP)

(73) Assignee: SHIMADZU CORPORATION, Kyoto-shi (JP)

(21) Appl. No.: 15/131,299

(22) Filed: Apr. 18, 2016

(51) Int. Cl. H01J 49/26; G01N 27/62

(52) U.S. Cl. CPC H01J 49/26; G01N 27/622

(57) ABSTRACT

An offset voltage adjusting portion is provided in an amplifying portion for applying respective pulse voltages to a pair of grid electrodes that structures a shutter gate grid. Because the pulse voltage is shifted in the direction of the voltage axis, with the amplitude and pulse width thereof maintained, when the offset voltage is adjusted, this enables a potential difference to be applied to the voltages that are applied to the front grid electrode and the rear grid electrode when the shutter gate grid is open. This potential difference produces an electric field for accelerating ions in the space between the pair of grid electrodes, thus accelerating the movement of ions immediately following the switching of the shutter gate grid from the closed state to the open state, enabling the pulse width of the ions to be narrowed.

### TECHNICAL FIELD

The present invention relates to an ion mobility spectrometer.

### BACKGROUND ART

When molecular ions generated from sample molecules move within a medium gas (or liquid), acted upon by an electric field, the ions move with a speed that is proportional to their mobility, determined by the strength of the electric field, the size of the molecule, and so forth. Ion mobility spectrometry (IMS) is a method of measurement that takes advantage of this mobility in order to analyze sample molecules. FIG. 5 is a schematic structural diagram of a typical ion mobility spectrometer disclosed in, for example, Patent Documents 1 and 2.

An ion mobility spectrometer is equipped with an ionizing region 10 for ionizing the component molecules within the sample and a drift region 11 for measuring the mobility of the ions, along with a detector 14 for detecting ions that are dispersed in the drift region 11. Moreover, a shutter gate grid 12 is provided at the boundary between the ionizing region 10 and the drift region 11 so as to send, into the drift region 11, ions generated in the ionizing region 10, doing in pulses that are limited to an extremely short time duration.

The shutter gate grid 12 is structured from a pair of grid electrodes 12a and 12b that are provided with a prescribed distance d therebetween in the direction in which the ions pass. FIG. 6 (a) is a schematic diagram of when the respective grid electrodes 12a and 12b are viewed from the direction in which the ions are introduced. In this example, in the grid electrodes 12a and 12b, large numbers of conductive wires 122 are extended, coplanar and in parallel, in respective circular ring-shaped holders 121. Because a conductive wire 122 in the rear grid electrode 12b is disposed in precisely the center position between two neighboring conductive wires 122 in the front grid electrode 12a, when the pair of grid electrodes 12a and 12b is viewed from the direction in which the ions are introduced, the conductive wires 122 are lined up at essentially equal intervals, and the gaps between adjacent conductive wires 122 form slit-shaped openings through which ions can pass, as illustrated in FIG. 6 (b).

In the ion mobility spectrometer described above, an electric field (an ion accelerating electric field), which exhibits a declining electropotential gradient in the direction in which the ions travel in the drift region 11, is formed from the DC voltages that are applied to each of the large number of ring-shaped electrodes 13 that are disposed in the ionizing region 10 and the drift region 11. When ions are introduced into the drift region 11 through the shutter gate grid 12 during only an extremely short time interval, then the ions advance along the declining electropotential gradient. Moreover, although not illustrated, a diffusing gas flow is formed in the opposite direction of the direction in which the ions move, in the drift region 11, where the ions move while colliding with the diffusing gas. In the process of this movement, the ions are separated in accordance with the sizes, etc., thereof, and ions of different sizes arrive at the detector 14 at different times. Because the resolution of the ion mobility spectrometry is greatly dependent on the time band (the pulse width) of the ions passing through the shutter gate grid 12, in order to improve the resolution the pulse width for the ions at the shutter gate grid 12 must be as short as possible.

FIG. 7 is a schematic drawing of the voltages applied to the pair of grid electrodes 12a and 12b, and the electropotential gradients in the ion optical axial direction. Note that in this example, it is positive ions that are envisioned. When identical voltages (Vref) are applied to both the front grid electrode 12a and the rear grid electrode 12b, the shutter gate grid 12 will be effectively in an open state, allowing ions to flow through the shutter gate grid 12 into the drift region 11. On the other hand, when voltages are applied to the respective grid electrodes 12a and 12b so that the electropotential of the rear grid electrode 12b will be several hundred volts higher than the electropotential of the front grid electrode 12a, then the shutter gate grid 12 will be in an essentially closed state, due to the electropotential barrier, cutting off the ions at the shutter gate grid 12. Typically the time over which the shutter gate grid 12 is open is between several hundred microseconds and several milliseconds, and the period with which it is opened is several tens of milliseconds.

As can be appreciated from FIG. 7, when the shutter gate grid 12 is in a closed state, a deep electropotential well is formed in the vicinity of the front grid electrode 12a, and thus the ions will have a tendency to accumulate in the electropotential well. Even if the shutter gate grid 12 is opened through the pair of grid electrodes 12a and 12b being put to the identical electropotential after this state, the ions that have accumulated in the electropotential well will not move rapidly, but rather there will be variability in terms of the time at which the ions pass through the space between the grid electrodes 12a and 12b. This variability in time is a factor that causes dispersion in the time with which ions that have identical mobility will arrive at the ion detector 14, reducing the temporal resolution of the spectrum.

### PRIOR ART DOCUMENTS

### Patent Documents

[Patent Document 1] Japanese Patent 2733750

[Patent Document 2] Japanese Unexamined Patent Application Publication 2005-174619

### SUMMARY OF THE INVENTION

### Problem Solved by the Present Invention

The present invention was created in order to solve the issue set forth above, and the object thereof is to improve the temporal resolution of the spectrum in an ion mobility spectrometer wherein ions enter into the drift regions through a shutter gate grid.

### Means for Solving the Problem

The present invention, in order to solve the problem set forth above, is an ion mobility spectrometer having an ionizing portion for generating sample component derivative ions, and a drift region in order to cause ions, generated by the ionizing portion, to move in order to separate the depending on mobility, comprising:

a) a shutter gate grid comprising a front grid electrode and a rear grid electrode disposed with a prescribed distance of separation in the direction of movement of the ions, between the ionizing portion and the drift region, in order to cut off or feed the ions into the drift region with short pulses; and

b) a gate grid controlling portion for applying, to the rear grid electrode, a voltage that is higher than that of the front grid electrode, so as to form an electropotential barrier to the ions in the space between the front grid electrode and the rear grid electrode when cutting off the ions with the shutter grid gate, and for applying, to the front grid electrode, a voltage that is higher than that of the rear grid electrode, so as to form an electric field for accelerating the ions in the space between the front grid electrode and the rear grid electrode, when the ions are passing through the shutter gate grid.

In the ion mobility spectrometer according to the present invention, the ionizing portion includes, in addition to an ion source for ionizing using an appropriate ionizing technique, component molecules within a sample that is applied, also means for generating product ions through breaking, through collision-induced dissociation, or the like, ions generated from the sample component.

Moreover, while, in the ion mobility spectrometer according to the present invention, the structure may be one that performs detection through directing and introducing into the ion detector those ions that have been separated depending on ion mobility in the drift region, the structure instead may be that of an ion mobility spectrometry-mass spectrometry (IMS-MS) structure, wherein the ions that have been separated in accordance with ion mobility are introduced into a mass spectrometer through quadrupole mass filtering, or the like, to further separate in accordance with the mass/electric charge ratio for detection.

In the conventional ion mobility spectrometer as described above, when the shutter gate grid is placed in the open state and ions are allowed to pass therethrough, the front grid electrode and the rear grid electrode are placed at the same electropotential. That is, essentially no electric field is formed in the space between the front grid electrode and the rear grid electrode, and thus there is no acceleration of ions in this space. In contrast, in the ion mobility spectrometer according to the present invention, when the shutter gate grid is placed in the open state, a voltage that is higher than that of the rear grid electrode is applied to the front grid electrode in order to form an electric field for accelerating the ions in the space between the front grid electrode and the rear grid electrode. Note that, of course, the polarity of the voltage applied to the grid electrodes or electrodes disposed within the drift region, or the like, will vary depending on the polarity of the ions. Consequently, the high “voltage” in the ion mobility spectrometer according to the present invention refers to a voltage that is expressed in terms of an absolute value.

In the ion mobility spectrometer according to the present invention, when the shutter gate grid is changed from the closed state to the open state, an electric field that accelerates ions is formed in the space between the front grid electrode and the rear grid electrode, and thus, for the ions that have accumulated to the front of the front grid electrode, movement thereof is accelerated by the effect of the electric field. Through this, an ion packet of a short time band will be introduced into the drift region, rather than the pulse width of the ions that pass through the gate grid while the shutter gate grid is open over a short time spreading out. The result is that those ions having identical mobility will pass through the drift region essentially simultaneously, making it possible to achieve a high temporal resolution.

However, if the kinetic energy that is applied when the ions pass through the shutter gate grid is too large, then the performance in separating the ions depending on the ion mobility within the drift region may suffer. Because of this, when the shutter gate grid is in the open state, it is undesirable for the potential difference that is applied to be too large, and desirable that the potential difference be adjustable.

Given this, in the ion mobility spectrometer according to the present invention, preferably the gate grid controlling portion includes a circuit for generating pulse voltages to be applied respectively to the front grid electrode and the rear grid electrode, and the structure may be one wherein the difference in voltages, when applying a voltage to the front grid electrode that is higher than that of the rear grid electrode, can be adjusted through adjusting an offset voltage of the pulse voltage that is applied to the front grid electrode and/or the pulse voltage that is applied to the rear grid electrode. Note that the adjustment to the offset voltage may be carried out using a variable resistor, or the like, as has typically been done conventionally.

Given this structure, the analysis technician is able to adjust the offset voltage appropriately, while observing a detection signal obtained from an ion detector disposed at the exit side of the drift region, for example, to make adjustments so as to minimize the signal width, for example, for ions having identical mobility. This enables adjustments so as to cause the temporal resolution to be extremely high. Of course, the structure may be such that not just the offset voltage, but the pulse width and/or amplitude of the pulsed voltage may be adjusted as well.

Moreover, in the ion mobility spectrometer according to the present invention, preferably the structure is such that the controlling portion includes: a first amplifying portion for inputting a pulse signal and for amplifying the pulse signal and supplying it to the front grid electrode; a second amplifying portion for inputting the pulse signal and for amplifying the pulse signal and supplying it to the rear grid electrode; a pulse signal generating portion for generating a standard pulse signal; and a polarity switching portion for either maintaining as-is, or inverting, depending on an instruction from the outside, the polarity of the standard pulse signal generated by the pulse signal generating portion and then supplying it to the first and second amplifying portions.

In the ion mobility spectrometer, the ions that are subject to analysis may either be positive or negative, depending on the sample components to be analyzed, but, as described above, in the conventional ion mobility spectrometer described above, when switching the polarity of ions that are subject to analysis, it is necessary to switch the connections of the wiring that applies the voltages to the grid electrodes. In contrast, with the structure set forth above, in the ion mobility spectrometer according to the present invention, an instruction may be applied to the polarity switching portion in accordance with the polarity of the ions that are to be analyzed, to either maintain as-is, or to invert, the polarity of the standard pulse signal, and apply it to the first and second amplifying portions, to thereby switch the polarity of the voltages applied to the front grid electrode and the rear grid electrode. This enables the polarity switching of the ions that are subject to analysis to be carried out simply and quickly.

Moreover, in the ion mobility spectrometer of the structure set forth above, the structure may include respective offset voltage adjusting portions for the first amplifying portion and the second amplifying portion. This eliminates the need to readjust the offset voltage even when the polarity of the ions has been switched, enabling analysis with high temporal resolution regardless of the polarity of the ions once the offset voltages have been adjusted.

### Effects of the Invention

The ion mobility spectrometer according to the present invention enables the temporal resolution of the spectrum to be improved through narrowing the pulse widths of the ion packets that are introduced in pulses into the drift region.

### BRIEF DESCRIPTION OF THE DRAWINGS

FIG. 1 is a schematic structural diagram of an ion mobility spectrometer according to an embodiment according to the present invention.

FIG. 2 is a circuit structural diagram of a gate grid controlling portion in an ion mobility spectrometer according to this embodiment.

FIG. 3 is a diagram illustrating the result of simulation of a voltage waveform when the offset voltage in the circuit illustrated in FIG. 2 has been adjusted.

FIG. 4 is a comparison of the voltage waveforms applied to the grid electrodes in the ion mobility spectrometer according to this embodiment and in a conventional ion mobility spectrometer, and a schematic diagram of the electropotential gradient on the ion optical axis when the shutter gate grid is open.

FIG. 5 is a schematic structural diagram of a typical ion mobility spectrometer.

FIG. 6 is a schematic drawing wherein the grid electrodes in FIG. 5 are viewed from the direction in which the ions are introduced.

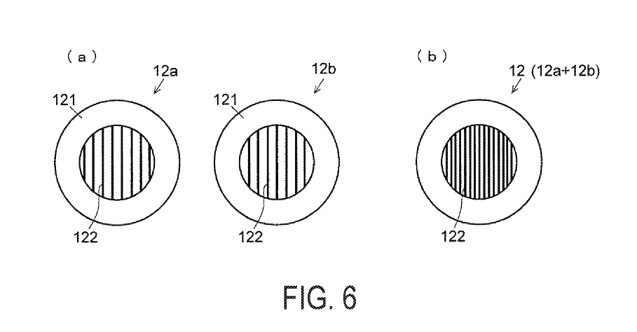

FIG. 7 is a schematic diagram of the voltage waveforms applied to the grid electrodes in the conventional ion mobility spectrometer, and of the electropotential gradient on the ion optical axis.

### DETAILED DESCRIPTION OF THE EXEMPLARY EMBODIMENTS

An embodiment of an ion mobility spectrometer according to the present invention will be explained in reference to the appended drawings.

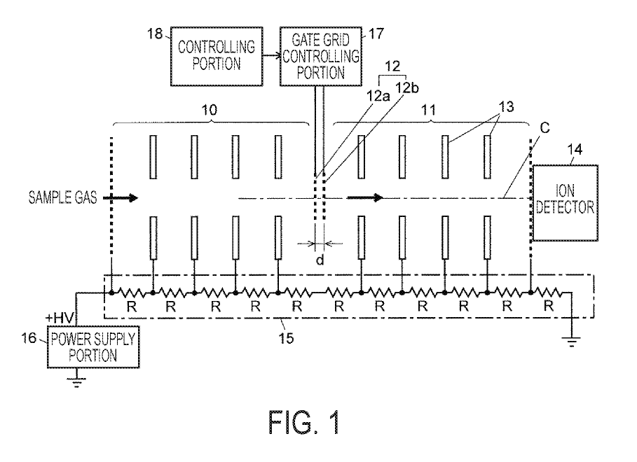

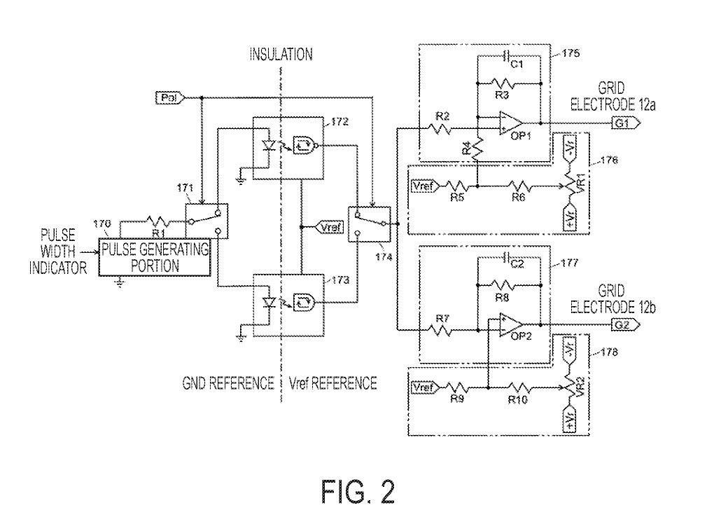

FIG. 1 is a schematic structural diagram of an ion mobility spectrometer that is one embodiment according to the present invention, and FIG. 2 is a circuit structural diagram of a gate grid controlling portion in the ion mobility spectrometer of this embodiment.

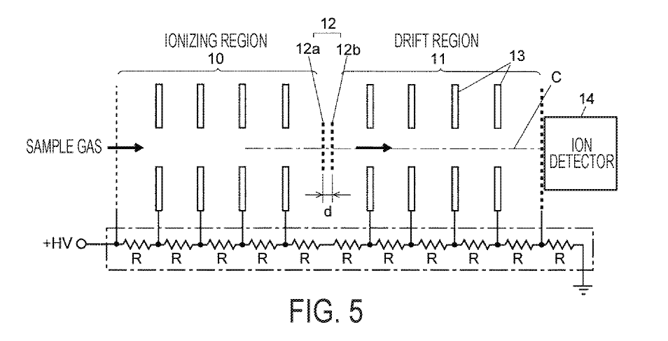

The basic structure of the ion mobility spectrometer in this embodiment is identical to that illustrated in FIG. 5. That is, the ion mobility spectrometer in the present embodiment has an ionizing region 10 and a drift region 11, and is provided with a shutter gate grid 12 at the boundary between the ionizing region 10 and the drift region 11. A plurality of ring-shaped electrodes 13 is disposed along the ion optical axis C in the ionizing region 10 and the drift region 11, where voltages obtained through voltage division, through a ladder resistance 15, of a prescribed DC voltage +HV, generated by a power supplying portion 16, are applied to the individual electrodes 13, to thereby form an electric field in the ionizing region 10 and the drift region 11.

The primary distinctive feature of the ion mobility spectrometer according to the present embodiment is in the circuit structure of the gate grid controlling portion 17 that applies the respective voltages to the pair of grid electrodes 12a and 12b. This circuit structure will be explained using FIG. 2.

A pulse signal that is generated in a pulse generating portion 170 passes through a resistance R1 and is supplied selectively, by a first switch 171, to an input terminal of a first photocoupler 172 or a second photocoupler 173. Both photocouplers 172 and 173 have Schmitt trigger built-in photodetectors, for waveform shaping, provided therein, wherein the first photocoupler 172 is of the inverted output type and the second photocoupler 173 is of the non-inverted appetite. Consequently, even though the pulse signals that are inputted into both photocouplers 172 and 173 are identical, the logic (that is, the “H” or “L” or the “1” or “0”) of the pulse signals that appear on the outputs of the two photocouplers 172 and 173 are mutually opposite.

The outputs of the two photocouplers 172 and 173 are selected by a second switch 174, and are inputted into both a non-inverting amplifying portion 175 and an inverting amplifying portion 177. The non-inverting amplifying portion 175 is structured including an op-amp OP1, resistances R2, R3, and R4, and a capacitor C1, and the inputted pulse signal is amplified under a prescribed amplification ratio. On the other hand, the inverting amplifying portion 177 is structured from an op-amp OP2, resistances R7 and R8, and a capacitor C2, and amplified under a prescribed application ratio after inverting the inputted pulse signal logic. The output of the non-inverting amplifying portion 175 is supplied to the front grid electrode 12a, and the output of the inverting amplifying portion 177 is supplied to the rear grid electrode 12b. Moreover, the non-inverting amplifying portion 175 is provided with an offset voltage adjusting portion 176 that includes resistances R5 and R6 and a variable resistance VR1, and, similarly, the inverting amplifying portion 177 is provided with an offset voltage adjusting portion 178 including resistances R9 and R10 and a variable resistance VR2.

In FIG. 2, +Vr is a positive power supply voltage, −Vr is a negative power supply voltage, and Vref is a reference voltage. The input side and the output side are insulated electrically by photocouplers 172 and 173, where the input sides of the photocouplers 172 and 173 use GND (ground) as the reference electropotential, while, in contrast, the output sides of the photocouplers 172 and 173 use the reference voltage Vref as the reference electropotential.

Based on a control signal supplied to the pulse generating portion 170 from the controlling portion 18, the pulse generating portion 170 generates pulse signals of a prescribed width with a prescribed period. In this case, the pulse width is the time over which the shutter gate grid 12 will be open, and thus, by adjusting the pulse width, it is possible to adjust the time over which the shutter gate grid 12 is open. The first switch 171 and second switch 174 are switched in coordination through the polarity switching signal Pol that is supplied from the controlling portion 18. For example, if the ions that are subject to analysis are positive ions, then, through the polarity switching signal Pol, both the first and second switches 171 and 174 are switched to the top side as shown in FIG. 2, that is, they select the first photocoupler 172. In this case, the pulse signal that is outputted from the pulse generating portion 170 has the logic thereof inverted as it passes through the first photocoupler 172, and then is inputted into the non-inverting amplifying portion 175 and the inverting amplifying portion 177.

The pulse signal that is inputted into the non-inverting amplifying portion 175 has the amplitude amplified, with the logic thereof inverted, and the electropotential that is applied to the inverting input terminal of the op-amp OP1 is the reference electropotential for this amplification. Because of this, when the electropotential that is applied to the inverting input terminal of the op-amp OP1 is changed through an adjustment to the variable resistance VR1, the offset of the pulse voltage of the output of the non-inverting amplifying portion 175 changes, to shift the signal waveform in the direction of the voltage axis while the amplitude thereof is maintained as-is. On the other hand, the pulse signal that is inputted into the inverted amplifying portion 177 has the amplitude amplified with the logic remaining as-is, and the electropotential that is applied to the non-inverting input terminal of the op-amp OP2 is the reference electropotential for this amplification. Because of this, when the electropotential that is applied to the non-inverting input terminal of the op-amp OP2 is changed through an adjustment to the variable resistance VR2, the offset of the pulse voltage that is the output of the inverted amplifying portion 177 changes, to shift the signal waveform in the direction of the voltage axis while the amplitude thereof is maintained as-is.

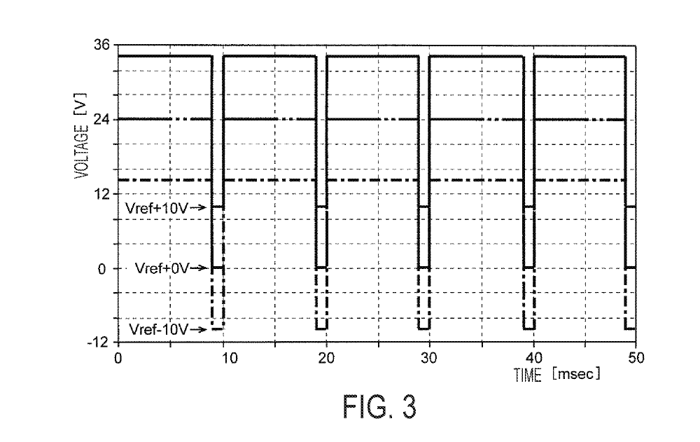

FIG. 3 is a diagram illustrating the result of a simulation of the voltage waveform when the offset voltage in the circuit illustrated in FIG. 2 is adjusted. As shown in FIG. 3, the offset voltage of the pulse voltage that is applied to the grid electrode 12a (or 12b) can be adjusted through changing the resistance value of the variable resistance VR1 (or VR2).

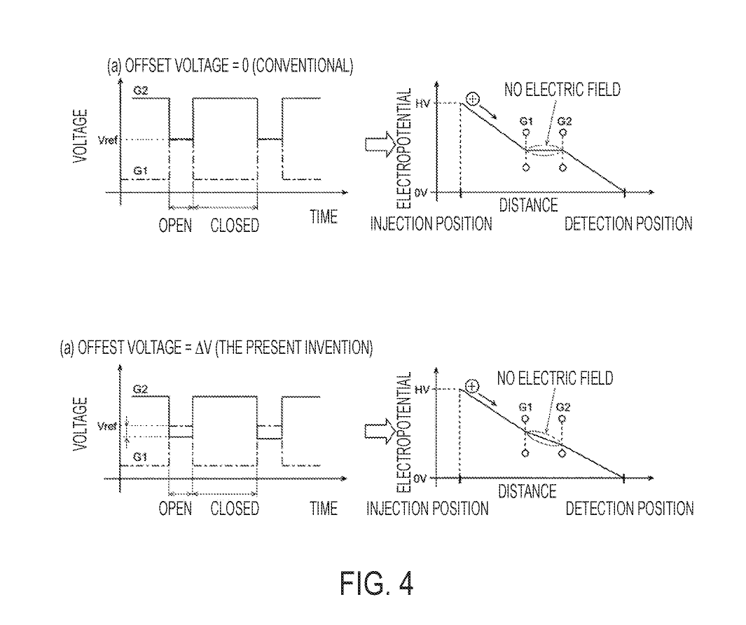

FIG. 4 is a comparison of the voltage waveforms applied to the grid electrodes 12a and 12b in the ion mobility spectrometer in the present embodiment and in the conventional ion mobility spectrometer, and schematic diagrams of the electropotential gradients on the ion optical axis when the shutter gate grid is open. As described above, in the conventional ion mobility spectrometer, the grid electrodes 12a and 12b are at identical electropotentials when the shutter gate grid 12 is open. As illustrated in FIG. 4 (a), this is the state wherein the offset voltage in the gate grid controlling portion 17 in the ion mobility spectrometer according to the present embodiment is 0, where the voltage value corresponding to the logic “H” of the pulse voltage that is applied to the front grid electrode 12a matches the voltage value corresponding to the logic “L” of the pulse voltage that is applied to the rear grid electrode 12b.

In contrast, in the ion mobility spectrometer according to the present embodiment, the variable resistance VR1 in the offset adjusting portion 176, as described above, and the variable resistance VR2 in the offset voltage adjusting portion 178, are adjusted to shift, in the direction of the voltage axis, the pulse voltages that are applied to the grid electrodes 12a and 12b. Consequently, the variable resistances VR1 and VR2 can be adjusted as appropriate to cause the voltage value corresponding to the logic “H” of the pulse voltage that is applied to the front grid electrode 12a to be higher, by a prescribed voltage, than the voltage value corresponding to the “L” logic of the pulse voltage that is applied to the rear grid electrode 12b, as illustrated in FIG. 4 (b). In this case, the electropotential gradient along the ion optical axis will gradually slope declining from the front grid electrode 12a toward the rear grid electrode 12b, as illustrated on the right in FIG. 4 (b), to form an electric field that accelerates ions in the space between the front grid electrode 12a and the rear grid electrode 12b.

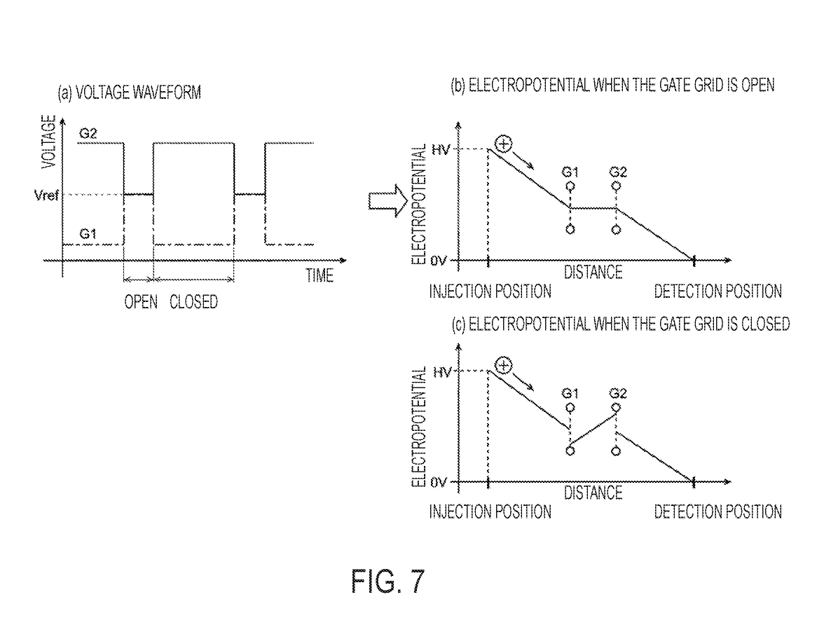

When the shutter gate grid 12 is opened from a state wherein the shutter gate grid 12 was closed and an electropotential barrier was formed in the vicinity of the shutter gate grid 12, as illustrated in FIG. 7 (c), and an accelerating electric field is formed in the vicinity of the shutter gate grid 12, as illustrated in FIG. 4 (b), then this accelerates the movement of the ions that have accumulated to the front of the electropotential barrier, to quickly pass through the shutter gate grid 12, to be introduced into the drift region 11. This causes the pulse width of the ions to be narrower when the ions pass through the shutter gate grid 12, thereby improving the temporal resolution of the spectrum.

However, if the electropotential gradient in the space between the front grid electrode 12a and the rear grid electrode 12b is too large, then the kinetic energy that is applied to the ions when passing through here will be too large, and the performance in separating the ions in accordance with the mobility in the drift region 11 will suffer. Of course, if the electropotential gradient in the space between the front grid electrode 12a and the rear grid electrode 12b is too small, then the effect of narrowing the pulse width of the ions in the shutter gate grid 12 will be inadequate. Given this, the potential difference between the grid electrodes 12a and 12b when the shutter gate grid 12 is open should be adjusted as appropriate in advance by the analyzing technician, or the like, through adjusting the variable resistance VR1 of the offset voltage adjusting portion 176 and the variable resistance VR2 in the offset voltage adjusting portion 178.

Specifically, the analyzing technician should adjust the variable resistances VR1 and VR2 so as to minimize the time band of the spectrum relative to ions derived from the target component while observing the ion detection signal obtained by the ion detector 14 by carrying out an analysis of a sample that includes a known component, such as, for example, a reference sample. This makes it possible to produce a state wherein the potential difference between the pair of grid electrodes 12a and 12b when the shutter gate grid 12 is open will be optimal or nearly optimal.

Note that, as is clear from FIG. 4 (b), if an offset voltage is applied so as to produce the potential difference between the pair of grid electrodes 12a and 12b when the shutter gate grid 12 is open, then the potential difference will be smaller when the shutter gate grid 12 is closed, reducing the electropotential barrier. However, this is no problem whatsoever in practice because the potential difference for forming the electropotential barrier to begin with is adequately large when compared to the potential difference that is produced by the offset voltage. Moreover, as necessary, the structure may be one wherein the amplitude of the pulse voltage can be increased, through making it possible to adjust the non-inverting amplifying portion 175 and the inverting amplifying portion 177.

If the ions that are subject to analysis are negative ions, then the first and second switches 171 and 174 are both switched to the bottom side in FIG. 2, by the polarity switching signal Pol that is supplied from the controlling portion 18, to select the second photocoupler 173. In this case, the pulse signal that is outputted from the pulse generating portion 170 will pass through the second photocoupler 173 with the logic thereof preserved, to be inputted into the non-inverting amplifying portion 175 and the inverting amplifying portion 177. That is, when analyzing positive ions, a pulse signal wherein the positive/negative logic has been inverted is inputted into the non-inverting amplifying portion 175 and the inverting amplifying portion 177. Because both the non-inverting amplifying portion 175 and the inverting amplifying portion 177 have the reference voltage Vref as the reference point for the amplification operation, when analyzing positive ions, as described above, a pulse voltage is generated wherein the positive and negative are inverted, centered on this reference voltage Vref. Consequently, in this case as well, an electric field wherein the ions (in this case, negative ions) are accelerated is produced in the space between the front grid electrode 12a and the rear grid electrode 12b, and, as a result, the pulse width of the ions when the ions pass through the shutter gate grid 12 will be narrowed. Moreover, in this case, the potential difference between the front grid electrode 12a and the rear grid electrode 12b will be the same as for the positive ion analysis, and thus there is no need to readjust the offset voltage using the variable resistances VR1 and VR2.

Note that, as described above, because the pulse width of the pulse signal that is generated by the pulse generating portion 170 is the time over which the shutter gate grid 12 is open, the time over which the shutter gate grid 12 is open can be adjusted through changing this pulse width. Moreover, for the amplitude of the pulse voltage that is applied to the grid electrodes 12a and 12b, the amplification ratios of the non-inverted amplifying portion 175 and of the inverted amplifying portion 177 may be adjusted (through, for example, adjusting the values of feedback resistances R3 and R8).

Note that the embodiment described above is no more than an example of the present invention, where, of course, even if there are arbitrary changes, corrections, or additions within a scope that does not deviate from the spirit or intent of the present invention, these are, of course, included within the patent claims of the present invention.

For example, the structure of the ionizing region in the ion mobility spectrometer of the embodiment set forth above may be changed arbitrarily, where, for example, an ion source through any of a variety of ionization techniques such as used in, for example, mass spectrometers may be substituted. Moreover, rather than measuring the mobility of the ionized sample molecules, product ions that are broken down through, for example, a collision-induced dissociation or optically-induced dissociation may be introduced into the drift region, to measure the mobility thereof.

Moreover, the present invention may also be applied to an ion mobility spectrometer-mass spectrometer wherein the ions that have been separated in accordance with the mobility thereof in the drift region are introduced into a quadrupole mass filter, or the like, to be separated further in accordance with the mass/electric charge ratio and then subjected to detection.

### Explanations of Reference Symbols

10: Ionizing Region
11: Drift Region
12: Shutter Gate Grid
12a: Front Grid Electrode
12b: Rear Grid Electrode
13: Ring-shaped Electrode
14: Ion Detector
15: Ladder Resistance
16: Power Supplying Portion
17: Gate Grid Controlling Portion
170: Pulse Generating Portion
171, 174: Switches
172, 173: Photocouplers
175: Non-Inverting Amplifying Portion
177: Inverting Amplifying Portion
176, 178: Offset Voltage Adjusting Portions
R1 through R10: Resistances
VR1, VR2: Variable Resistances
C1, C2: Capacitors
OP1, OP2: Op-amps
18: Controlling Portion

What is claimed:

1. An ion mobility spectrometer, having an ionizing portion for generating sample component derivative ions, and a drift region in order to cause ions, generated by the ionizing portion, to move in order to separate the depending on mobility, comprising:
a) a shutter gate grid comprising a front grid electrode and a rear grid electrode disposed with a prescribed distance of separation in the direction of movement of the ions, between the ionizing portion and the drift region, in order to cut off or feed the ions into the drift region with short pulses; and
b) a gate grid controlling portion for applying, to the rear grid electrode, a voltage that is higher than that of the front grid electrode, so as to form an electropotential barrier to the ions in the space between the front grid electrode and the rear grid electrode when cutting off the ions with the shutter grid gate, and for applying, to the front grid electrode, a voltage that is higher than that of the rear grid electrode, so as to form an electric field for accelerating the ions in the space between the front grid electrode and the rear grid electrode, when the ions are passing through the shutter gate grid.

2. The ion mobility spectrometer as set forth in claim 1, wherein:
the gate grid controlling portion includes a circuit for generating pulse voltages to be applied respectively to the front grid electrode and the rear grid electrode, and the structure may be one wherein the difference in voltages, when applying a voltage to the front grid electrode that is higher than that of the rear grid electrode, can be adjusted through adjusting an offset voltage of the pulse voltage that is applied to the front grid electrode and/or the pulse voltage that is applied to the rear grid electrode.

3. The ion mobility spectrometer as set forth in claim 2, wherein:
the controlling portion includes: a first amplifying portion for inputting a pulse signal and for amplifying the pulse signal and supplying the amplified pulse signal to the front grid electrode; a second amplifying portion for inputting the pulse signal and for amplifying the pulse signal and supplying the amplified pulse signal to the rear grid electrode; a pulse signal generating portion for generating a standard pulse signal; and a polarity switching portion for either maintaining as-is, or inverting, depending on an instruction from the outside, the polarity of the standard pulse signal generated by the pulse signal generating portion and then supplying standard pulse signal to the first and second amplifying portions.

4. The ion mobility spectrometer as set forth in claim 3, wherein:
the first amplifying portion and the second amplifying portion each have offset electropotential adjusting portions.

5. A method of controlling an ion mobility spectrometer, having an ionizing portion for generating sample component derivative ions, and a drift region in order to cause ions, generated by the ionizing portion, to move in order to separate the depending on mobility and a shutter gate grid comprising a front grid electrode and a rear grid electrode disposed with a prescribed distance of separation in the direction of movement of the ions, between the ionizing portion and the drift region, in order to cut off or feed the ions into the drift region with short pulses; the method comprising:
applying, to the rear grid electrode, a voltage that is higher than that of the front grid electrode, so as to form an electropotential barrier to the ions in the space between the front grid electrode and the rear grid electrode when cutting off the ions with the shutter grid gate, and
applying, to the front grid electrode, a voltage that is higher than that of the rear grid electrode, so as to form an electric field for accelerating the ions in the space between the front grid electrode and the rear grid electrode, when the ions are passing through the shutter gate grid.

6. The method of controlling the ion mobility spectrometer as set forth in claim 5, further comprising
generating pulse voltages to be applied respectively to the front grid electrode and the rear grid electrode, and the structure may be one wherein the difference in voltages, when applying a voltage to the front grid electrode that is higher than that of the rear grid electrode, can be adjusted through adjusting an offset voltage of the pulse voltage that is applied to the front grid electrode and/or the pulse voltage that is applied to the rear grid electrode.

7. The method of controlling the mobility spectrometer as set forth in claim 6, further comprising
inputting a pulse signal and amplifying the pulse signal and supplying the amplified pulse signal to the front grid electrode by a first amplifying portion;
inputting the pulse signal and amplifying the pulse signal and supplying the amplified pulse signal to the rear grid electrode by a second amplifying portion;
generating a standard pulse signal by a pulse signal generating portion;
either maintaining as-is, or inverting, depending on an instruction from the outside, the polarity of the standard pulse signal generated by the pulse signal generating portion and then supplying standard pulse signal to the first and second amplifying portions, by a polarity switching portion.

8. The method of controlling the mobility spectrometer as set forth in claim 7, wherein:
the first amplifying portion and the second amplifying portion each have offset electropotential adjusting portions.
